(19) United States
(12) Patent Application Publication
(10) Pub. No.: US 2026/0126374 A1
(43) Pub. Date: May 7, 2026

(54) METHOD FOR DETERMINING FLATNESS OF CATALYST COATED MEMBRANE (CCM) AND METHOD FOR OBTAINING CCM

(71) Applicant: Taiwan Carbon Nano Technology Corporation, Miaoli County (TW)

(72) Inventors: Kuang-Che Lee, Miaoli County (TW); Chia-Hung Li, Miaoli County (TW); Chun-Hsien Tsai, Miaoli County (TW)

(21) Appl. No.: 18/940,121

(22) Filed: Nov. 7, 2024

(51) Int. Cl. G01N 19/02; H01M 8/1086

(52) U.S. Cl. CPC G01N 19/02; H01M 8/1093

(57) ABSTRACT

The present invention discloses a method for obtaining a catalyst coated membrane (CCM), including obtaining a friction coefficient of a material to be tested, identifying whether the friction coefficient is within a range from 0.1 to 15 or not, and if so, using the material to be tested in a CCM manufacturing process to obtain the CCM, wherein the flatness of the CCM and the friction coefficient of the material to be tested are positively correlated.

### FIELD OF THE INVENTION

The present invention is related to a method for determining the flatness of a CCM and a method for obtaining the CCM. In particular, the present invention is related to a method for obtaining a flat CCM according to a friction coefficient of a material.

### BACKGROUND OF THE INVENTION

A fuel cell is an energy conversion device that can directly convert chemical energy stored in hydrogen fuel and oxidant into electrical energy through electrochemical reactions. Fuel cells have the characteristics of high energy conversion efficiency and no waste gas emissions, and they are considered to be one of the most promising solutions to solve the energy crisis and environmental pollution issues. Fuel cells have great application prospects especially in transportation (such as cars, ships and backup power supplies). Because of these outstanding characteristics, the development and application of fuel cell technologies has attracted much attention from governments and enterprises around the world.

Catalyst coated membrane (CCM) in a fuel cell is one of the important components in the fuel cell, and the main preparation method therefor is to coat a catalyst slurry on a polymeric membrane and dry the coated polymeric membrane to form the CCM. When coating catalyst slurry on both sides of the polymeric membrane, the solvents used in most catalysts are alcohols (such as methanol, ethanol, propanol, isopropyl alcohol, n-propanol or glycerin, etc.) and most polymeric membranes are perfluorosulfonic acid membranes. Therefore, when a catalyst is coated on the polymeric membrane, the presence of alcohol solvents will cause the polymeric membrane to swell, which affects the quality of the polymeric membrane.

Among existing CCM preparation methods, how to ensure the surface uniformity and flatness of CCM has always been one of the key research and development technologies in this field. Although there are many preparation methods for CCM (such as transfer printing method, roll-to-roll (R2R) coating method, brushing method, ultrasonic spray method and vacuum adsorption), these methods need to be carried out under various preparation limitations, resulting in their respective shortcomings, which means that the problems of CCM swelling and deformation have not yet been completely solved today.

The problem of CCM swelling and deformation should be solved, and it is desired to obtain a flat CCM under the lowest preparation limitation and effectively improve the quality of the CCM.

### SUMMARY OF THE INVENTION

The present invention provides a method for determining the flatness of a CCM and a method for obtaining the CCM. The friction coefficient of the material to be tested is used as a basis for determining the flatness of the CCM, and the material with a high friction coefficient is applied to a CCM manufacturing process, thereby a flat CCM can be obtained.

In one aspect, the present invention discloses a method for determining the flatness of a CCM, wherein the CCM includes a material to be tested, and the method includes: performing a friction testing for the material to be tested to obtain a friction coefficient of the material to be tested, comparing the friction coefficient to decide whether the friction coefficient falls into a predetermined range from 0.1 to 15, and determining the flatness of the CCM containing the material to be tested based on a decision whether the friction coefficient falls within the predetermined range, wherein the flatness of the CCM and the friction coefficient of the material to be tested are positively correlated.

In another aspect, the present invention discloses a method for obtaining a catalyst coated membrane (CCM) having a flatness, including: performing a friction testing for a material to be tested to obtain a friction coefficient of the material to be tested, and using the material to be tested in a CCM manufacturing process if the friction coefficient ranges from 0.1 to 15, wherein the flatness of the CCM and the friction coefficient of the material to be tested are positively correlated.

The present invention further discloses a method for obtaining a catalyst coated membrane (CCM) having a flatness, including: obtaining a friction coefficient of a material to be tested, identifying whether the friction coefficient is within a range from 0.1 to 15 or not, and if so, using the material to be tested in a CCM manufacturing process to obtain the CCM, wherein the flatness of the CCM and the friction coefficient of the material to be tested are positively correlated.

### BRIEF DESCRIPTION OF THE DRAWINGS

The objectives and advantages of the present invention will become more readily apparent to those ordinarily skilled in the art after reviewing the following detailed descriptions and accompanying drawings.

FIG. 1 is a cross-sectional view of a CCM in the prior art.

FIG. 2 is a flow chart according to the method for determining the flatness of the CCM of the present invention.

FIG. 3 is a diagram showing the relationship between the friction coefficients of various materials and the flatness of a double-sided CCM.

FIG. 4 is a flow chart according to a manufacturing test of the present invention.

FIG. 5 is a flow chart according to the method for obtaining the CCM of the present invention.

### DETAILED DESCRIPTION OF THE PREFERRED EMBODIMENTS

The present invention will now be described more specifically with reference to the following embodiments. It is to be noted that the following descriptions of the preferred embodiments of this invention are presented herein for purpose of illustration and description only; they are not intended to be exhaustive or to be limited to the precise form disclosed.

A fuel cell usually contains a polymeric membrane, which is sandwiched between an anode catalyst layer and a cathode catalyst layer to form a membrane electrode assembly (MEA). The catalyst layer is coated on the polymeric membrane, and this structure is called a catalyst coated membrane (CCM). As used herein, the term “polymeric membrane” includes a proton exchange membrane (PEM), an anion exchange membrane (AEM) and a perfluorosulfonic acid ion-exchange membrane. The polymeric membrane can be selected in the present invention according to actual needs to transport different ions.

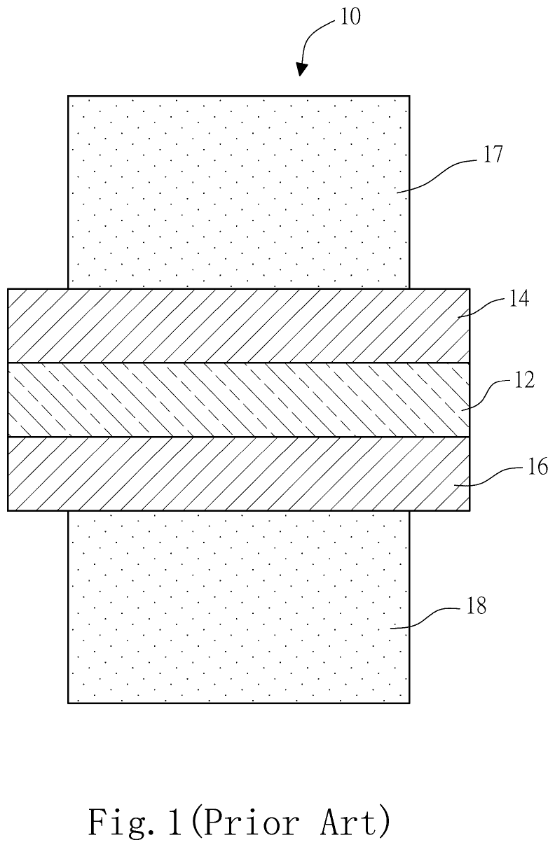

FIG. 1 shows a cross-sectional view of a CCM 10 in the prior art. The CCM 10 is a double-sided CCM, including a polymeric membrane 12, an anode catalyst layer 14 coated on the upper surface of the polymeric membrane 12, and a cathode catalyst layer 16 coated on the lower surface of the polymeric membrane 12. In addition, the CCM 10 further includes a gas diffusion layer 17 disposed on the anode side and a gas diffusion layer 18 disposed on the cathode side, which have the functions of supporting the catalyst layers, collecting currents, conducting gas, and discharging reaction product (i.e. water).

In one aspect of the present invention, a method for determining the flatness of a CCM is provided. According to the method for determining the flatness of the CCM of the present invention, assuming that a material to be tested is used in the CCM, the flatness of the CCM containing the material to be tested can be determined by the friction coefficient of the material to be tested. The material to be tested can be disposed at any suitable position in the CCM. Preferably, the material to be tested is combined with at least one catalyst layer in the CCM. For example, the material to be tested can be combined with the anode catalyst layer 14, the cathode catalyst layer 16, or both in FIG. 1.

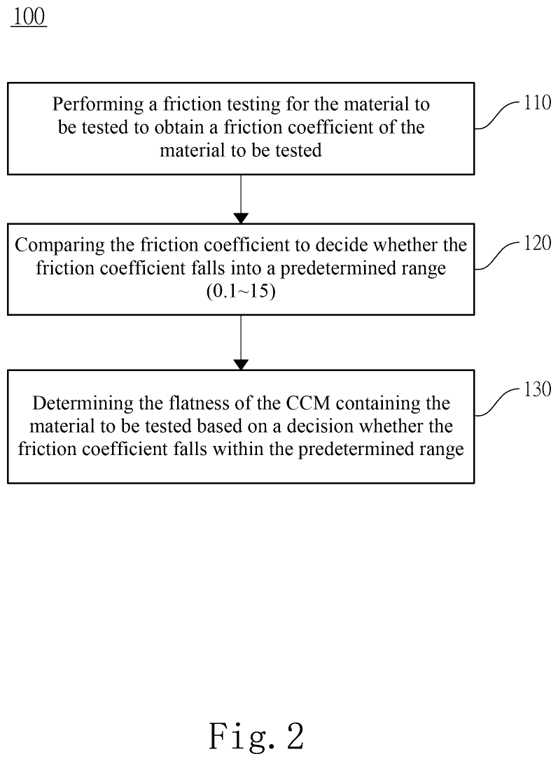

FIG. 2 is a flow chart according to a method 100 for determining the flatness of the CCM of the present invention. In Step 110, a friction testing for the material to be tested is performed to obtain a friction coefficient of the material to be tested. In Step 120, the friction coefficient is compared to a predetermined range from 0.1 to 15 to decide whether the friction coefficient falls into the predetermined range. In Step 130, the flatness of the CCM containing the material to be tested is determined based on a decision whether the friction coefficient falls within the predetermined range. The friction testing used in the present invention includes various methods that can obtain the friction coefficient of the material to be tested, such as methods to obtain the static friction coefficient or kinetic friction coefficient between two pieces of the same material to be tested. In a preferred embodiment of the present invention, the friction testing is ASTM D1894, and the friction coefficient is the static friction coefficient. However, it should be understood that the friction testing used in the present invention is not limited to the method in the preferred embodiment. In addition, a skilled person in the field should understand that when the friction testing is performed for different materials to be tested, the same testing should be used so that there is a consistent standard among the friction coefficients of the different materials to be tested.

In Step 120 of FIG. 2, different predetermined ranges can be set according to actual needs. For example, the predetermined range may be friction coefficients from 0.1 to 15 or in any range therebetween, preferably from 1 to 15 or in any range therebetween, and more preferably from 5 to 15 or in any range therebetween. In order to establish the relationship between the friction coefficient of the material to be tested and the flatness of the CCM, experiments as shown in Table 1 for different materials to be tested were conducted in the present invention. In the experiments in Table 1, the friction coefficients of different materials to be tested were obtained by ASTM D1894 friction testing, the different materials to be tested were used to prepare double-sided CCMs, and the surface flatness of each CCM produced was observed. In this experiment, the material to be tested was formed as a substrate for lamination with one of the catalyst layers in the double-sided CCM under a pressure of 1.288 Kgf/cm².

TABLE 1

| Serial number | 5 | 4 | 3 | 2 | 1 |
|---|---|---|---|---|---|
| Material of | Material 5 | Material 4 | Material 3 | Material 2 | Material 1 |
| substrate | | | | | |
| Friction | 13.748 | 7.79 | 6.55 | 1.076 | 0.115 |
| coefficient | | | | | |
| (D1894) | | | | | |
| Pressure in the | 1.288 | 1.288 | 1.288 | 1.288 | 1.288 |
| lamination | | | | | |
| process (Kgf/cm²) | | | | | |
| Status of | Flat surface | Flat surface | Flat surface | Swelling | Swelling |
| the produced | No swelling | No swelling | No swelling | Big | |
| double-sided CCM | and wrinkle | and wrinkle | and wrinkle | wrinkle | |

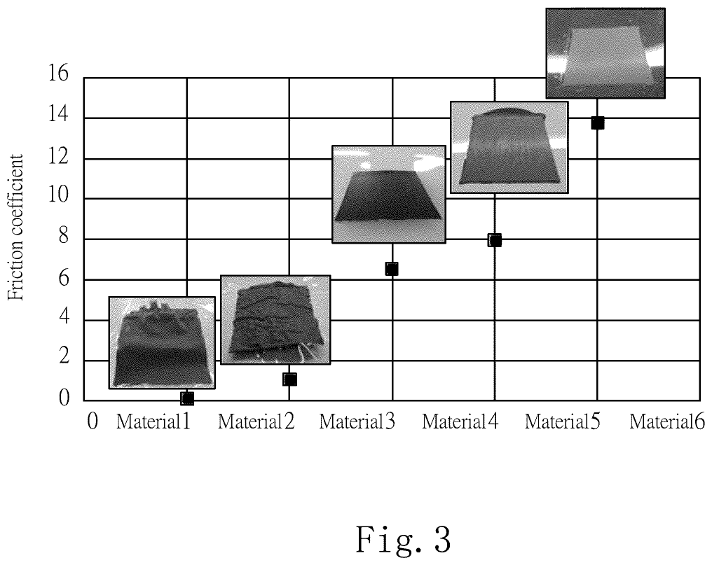

As shown in Table 1, each of Materials 1 to 5 has respective friction coefficients. When the materials 1 to 5 are used as substrate materials and laminated with the catalyst layer in the double-sided CCM, the experimental results show that the greater the friction coefficient, the flatter the resulting double-sided CCM. As shown in FIG. 3, there are still swelling defects on the surfaces of the double-sided CCMs made of Material 1 and Material 2. The double-sided CCMs made of Materials 3 to 5 have smooth surfaces and no swelling and wrinkle. The experimental results above can be used as a basis for determining the predetermined range in Step 120 of FIG. 2 of the present invention, and can also be used as a reference for determining the flatness of the CCM in Step 130. For example, the predetermined range in Step 120 can be set to friction coefficients from 1 to 15 based on known experimental results. In Step 130, when the friction coefficient of the material to be tested falls within this predetermined range, it is determined that the CCM containing the material to be tested has a flat surface.

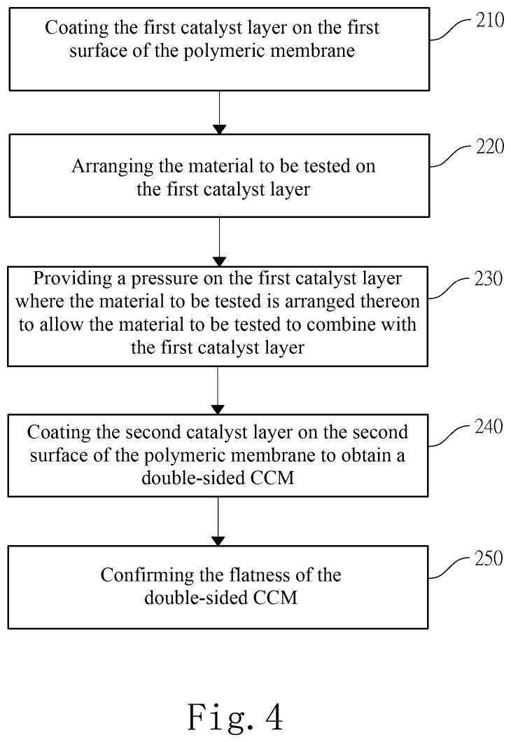

The materials suitable for preparing double-sided CCM can be selected by the method for determining the flatness of the CCM of the present invention. For unknown materials to be tested, on a condition that the friction coefficient of the material to be tested matches a predetermined range, a further manufacturing test can be performed for the material to be tested to determine the surface characteristics of the CCM containing the material to be tested. FIG. 4 is a flow chart of the manufacturing test of the present invention. Although the manufacturing test in FIG. 4 is a method of preparing a double-sided CCM, it should be understood that the materials, selected by the method for determining the flatness of the CCM of the present invention, can also be used to prepare CCMs having other structures. That is, the manufacturing test in FIG. 4 is only an example, and a skilled person in the art can adjust the steps of the manufacturing test according to actual needs.

Please refer to FIG. 4. First, a polymeric membrane is provided and a first catalyst layer is coated on the first surface of the polymeric membrane in Step 210. Preferably, the polymeric membrane is a perfluorosulfonic acid membrane, and the first catalyst layer is a mixture including, for example, carbon powder, noble metals or metal oxides, perfluorosulfonic acid resin, alcohol solvents and water. The way of coating the first catalyst layer on the first surface may be by various methods commonly used in the art, such as transfer printing, direct coating, brush coating, ultrasonic spray or vacuum adsorption. In Step 220, the material to be tested that has been screened out by the method of FIG. 2 is disposed on the first catalyst layer, wherein the material to be tested at least partially overlaps the first catalyst layer. For example, the material to be tested may be a layered structure disposed on the first catalyst layer, or the material to be tested may cover a part of the first catalyst layer.

In Step 230, a pressure is provided to the first catalyst layer provided with the material to be tested, to allow the material to be tested to combine with the first catalyst layer. The method of providing the pressure to the first catalyst layer in the present invention can be carried out in various environments, such as normal temperature lamination, thermal lamination, vacuum pressing, etc. In the preferred embodiment of the present invention, the method of providing the pressure to the first catalyst layer is normal temperature lamination or vacuum lamination. In Step 230, the pressure applied to the first catalyst layer is between 0 and 380 kgf/cm², preferably between 0 and 50 kgf/cm², and more preferably between 0 and 10 kgf/cm². For example, when a normal temperature laminating process is performed, the pressure applied to the first catalyst layer is 1.288 kgf/cm².

In Step 240, a second catalyst layer is coated on the second surface of the polymeric membrane to obtain a double-sided CCM. According to the actual needs of the double-sided CCM, the components of the second catalyst layer and the first catalyst layer may be the same or different, and the thicknesses of the second catalyst layer and the first catalyst layer may also be the same or different. The method of coating the second catalyst layer on the second surface may be by various methods commonly used in the art, such as transfer printing, direct coating, brush coating, ultrasonic spray or vacuum adsorption. After the double-sided CCM produced through the above steps is dried, in Step 250, the flatness of the double-sided CCM is confirmed. Although the method in FIG. 4 only involves the steps of preparing the first catalyst layer, the material to be tested and the second catalyst layer, a skilled person in the art will understand that the CCM may also include other structures, so the manufacturing test may also include steps for preparing other structures, including, for example, steps for preparing other layer structures.

By using the method in FIG. 2 to screen out the materials suitable for the CCM manufacturing process, and using the manufacturing test in FIG. 4 to confirm the flatness of the double-sided CCM, it was found that the flatness of the double-sided CCM becomes better, if the materials with higher friction coefficients are used to fix the polymeric membrane during the manufacturing process and the double sides of the polymeric membrane are coated. This result shows that there is a significant positive correlation between the flatness of the CCM and the friction coefficient of the material.

When preparing a CCM with a polymeric membrane (especially a perfluorosulfonic acid ion-exchange membrane) by a transfer printing method, the transfer temperature is as high as 210° C. (which is higher than the melting point (200° C.) of the perfluorosulfonic acid ion-exchange membrane). Studies have pointed out that when the temperature is higher than the glass transition temperature (100˜110° C.), the polymer chains will reorganize or move to result in structural changes, which causes the properties of the polymeric membrane to be decreased. Since high temperatures will destroy the structure of the polymeric membrane, high temperatures should be avoided during the CCM manufacturing process. Departing from the conventional technologies, the materials selected by the method of the present invention can be applied to the CCM manufacturing process performed under normal temperature to solve the high temperature limitation in the traditional manufacturing processes. The method of the present invention uses the friction coefficient of the material as the basis for determining the flatness of the CCM, and completely solves the problems of CCM swelling and deformation using the existing manufacturing processes in this field without damaging the structure of the polymeric membrane. Since there is no need to set various restrictions on the existing manufacturing processes, the present invention improves the surface uniformity and flatness of CCM with minimum restrictions.

In another aspect, the method of the present invention also overcomes the problems of low utilization of the catalyst layer caused by traditional methods and poor yield due to multiple catalyst coatings. Since the surface of the CCM made of a material with a high friction coefficient is flat, it is beneficial to coat a thicker catalyst layer. As shown in Table 2, as the thickness of the mold increases, the thicknesses of the first catalyst layer and the second catalyst layer also increase, and no surface wrinkle occurs. In the double-sided CCM prepared according to the method of the present invention, each of the first catalyst layer and the second catalyst layer has a thickness ranging from 5 to 80 μm. Specifically, when the mold thickness is 100 μm, the thicknesses of the first catalyst layer and the second catalyst layer are, for example, 17.0 μm and 17.6 μm, respectively. When the mold thickness is 200 μm, the thicknesses of the first catalyst layer and the second catalyst layer are, for example, 37.3 μm and 36.6 μm, respectively. When the mold thickness is 300 μm, the thicknesses of the first catalyst layer and the second catalyst layer are, for example, 41.3 μm and 60.0 μm, respectively. When the mold thickness is 400 μm, the thicknesses of the first catalyst layer and the second catalytic layer are, for example, 61.0 μm and 76.3 μm, respectively.

TABLE 2
Thickness control data of the coated catalyst layer

| | | Surface | Thickness | Surface | Thickness |
|---|---|---|---|---|---|
| | | status of | of the | status of | of the |
| | | the first | first | the second | second |
| Serial | Mold | catalyst | catalyst | catalyst | catalyst |
| number | Thickness | layer | layer (μm) | layer | layer (μm) |
| 1 | 100 μm | Flat | 17.0 | Flat | 17.6 |
| 2 | 200 μm | Flat | 37.3 | Flat | 36.6 |
| 3 | 300 μm | Flat | 41.3 | Flat | 60.0 |
| 4 | 400 μm | Flat | 61.0 | Flat | 76.3 |

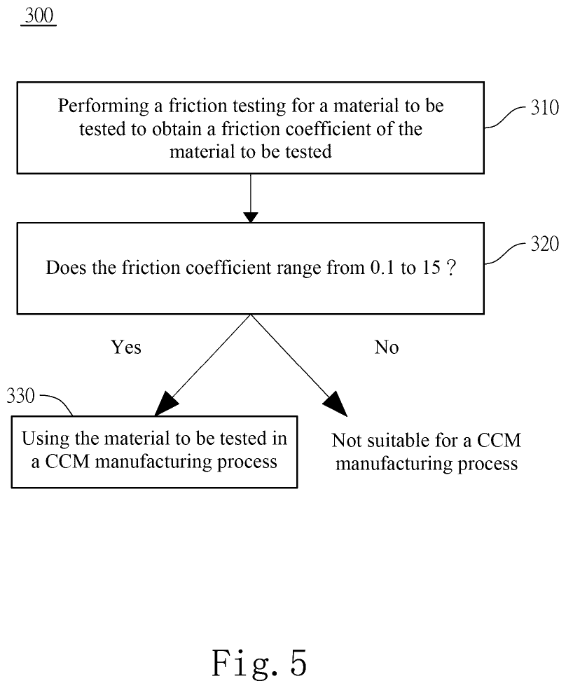

In another aspect of the present invention, a method for obtaining the CCM is provided. FIG. 5 is a flow chart according to a method 300 for obtaining the CCM of the present invention. First, a friction testing for the material to be tested is performed to obtain the friction coefficient of the material to be tested in Step 310. In Step 320, it is determined whether the friction coefficient ranges from 0.1 to 15. If the friction coefficient is within a range from 0.1 to 15, the material to be tested is used in a CCM manufacturing process in Step 330. On the contrary, if the friction coefficient does not range from 0.1 to 15, it means that the material to be tested is not suitable for the CCM manufacturing process. In a preferred embodiment of the present invention, the friction testing is ASTM D1894, and the friction coefficient is the static friction coefficient. The friction coefficient range used in Step 320 can be set to different ranges according to actual needs, such as a range between 0.1 and 15 or any range in between, preferably a range between 1 and 15 or any range in between, and more preferably a range between 5 and 15 or any range in between.

The term “CCM manufacturing process” used in the present invention refers to various manufacturing processes that can be used to prepare the CCM in the art, preferably the manufacturing processes for preparing the double-sided CCM. For example, the CCM manufacturing process can be selected from one of transfer printing method, roll-to-roll (R2R) coating method, brush coating, ultrasonic spray method and vacuum adsorption. In this CCM manufacturing process, the material to be tested is combined with at least one catalyst layer in the double-sided CCM to improve the flatness of the double-sided CCM. According to the present invention, the materials with a friction coefficient ranging from 0.1 to 15 and suitable for the CCM manufacturing process include silicone, rubber, silicone rubber, polymers, metals, metal oxides and the combination thereof. Preferably, the materials suitable for the CCM manufacturing process include silicone, rubber, silicone rubber, polymers and the combination thereof. More preferably, the materials suitable for the CCM manufacturing processes include silicone, rubber, silicone rubber and the combination thereof.

There may be an alternative embodiment for the method 300 for obtaining the CCM of the present invention. In Step 310, the means of obtaining the friction coefficient of the material to be tested is not limited to the friction testing, and other methods for obtaining the friction coefficient of the material to be tested may also be used. For example, the friction coefficient of the material to be tested may be obtained from known databases, product manuals, or any public information. If the friction coefficient of the material to be tested is obtained by means other than the friction testing, Step 310 in FIG. 5 is omitted and Steps 320 and 330 are performed sequentially, to confirm whether the friction coefficient of the material to be tested ranges from 0.1 to 15 and use the material to be tested in the CCM manufacturing process.

The embodiments of the present invention are described below.

### Embodiment 1—The Friction Testing (ASTM D1894)

First, two pieces of materials to be tested of different sizes are prepared as test samples, wherein the sample sizes are 250 mm×130 mm and 63.5 mm×63.5 mm, respectively. The two test samples are overlapped and placed horizontally, and a weight of 200 g is provided on the two test samples. The weight is pulled at a speed of 150 mm/min and the pulling force Fs required to pull the weight (i.e., the static friction force fs between the two pieces of test samples) is measured. Because the weight provides a normal positive pressure W on the test samples, the static friction coefficient us is equal to the ratio of the static friction force fs to the normal positive pressure W according to the friction force formula (fs=W×μs). When the pulling force Fs is larger, the measured static friction coefficient us is also larger.

### Embodiment 2—The Manufacturing Test

In this manufacturing test, the perfluorosulfonic acid ion membrane, Nafion 212 membrane (manufactured by DuPont), is used as the proton exchange membrane in the CCM. The product parameters are as follows: the thickness is 50.8 μm, the density is 100 g/m², the specification is 61 cm*L, the conductivity is 0.083 S/cm, and the switching capacity is 0.95-1.01 meq/g. There is a coversheet on the upper surface and a backing film on the lower surface of Nafion 212.

Step 1: removing the coversheet on the upper surface of Nafion 212 membrane.
Step 2: coating the first catalyst layer on the upper surface. The slurry components of the first catalyst layer are 1.8 grams of carbon powder, 4 grams of perfluorosulfonic acid solution D520 and 6 grams of isopropyl alcohol (IPA). The coated first catalyst layer is dried at 70° C. to obtain a first catalyst layer with a thickness of 30 μm.
Step 3: covering the material to be tested on the first catalyst layer.
Step 4: performing a laminating process under a pressure of 1.288 kgf/cm² at room temperature to combine the material to be tested with the first catalyst layer.
Step 5: removing the backing film on the lower surface of Nafion 212 membrane.
Step 6: coating the second catalyst layer on the lower surface. The slurry components of the second catalyst layer are 1.8 grams of carbon powder, 4 grams of perfluorosulfonic acid solution D520 and 6 grams of IPA. The coated second catalyst layer is dried at 70° C. to obtain the second catalyst layer with a thickness of 30 μm.
Step 7: observing whether the surface of the produced double-sided CCM is flat or not.

By using the method for determining the flatness of the CCM and the method for obtaining the CCM therefrom in the present invention, the CCM can be prepared under the lowest manufacturing restrictions, which completely solves the problem of CCM swelling and deformation, and increases the thickness of the catalyst layer at the same time.

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

1. A method for determining a flatness of a catalyst coated membrane (CCM), wherein the CCM comprises a material to be tested, and the method comprises:
performing a friction testing for the material to be tested to obtain a friction coefficient of the material to be tested;
comparing the friction coefficient to decide whether the friction coefficient falls into a predetermined range from 0.1 to 15; and
determining the flatness of the CCM containing the material to be tested based on a decision whether the friction coefficient falls within the predetermined range, wherein the flatness of the CCM and the friction coefficient of the material to be tested are positively correlated.

2. The method as claimed in claim 1, wherein the CCM comprises a polymeric membrane and at least one catalyst layer, and the material to be tested is used to combine with the at least one catalyst layer in the CCM.

3. The method as claimed in claim 2, wherein the polymeric membrane is a perfluorosulfonic acid ion-exchange membrane.

4. The method as claimed in claim 2, further comprising:
performing a manufacturing test for the material to be tested under the condition that the friction coefficient falls within the predetermined range, wherein the manufacturing test comprises the following steps:
coating a first catalyst layer on a first surface of the polymeric membrane;
arranging the material to be tested on the first catalyst layer;
providing a pressure on the first catalyst layer where the material to be tested is arranged thereon to allow the material to be tested to combine with the first catalyst layer;
coating a second catalyst layer on a second surface of the polymeric membrane to obtain a double-sided CCM; and
confirming the flatness of the double-sided CCM.

5. The method as claimed in claim 1, wherein the predetermined range is in a range from 1 to 15.

6. The method as claimed in claim 1, wherein the predetermined range is in a range from 5 to 15.

7. A method for obtaining a catalyst coated membrane (CCM) having a flatness, comprising:
performing a friction testing for a material to be tested to obtain a friction coefficient of the material to be tested; and
using the material to be tested in a CCM manufacturing process if the friction coefficient ranges from 0.1 to 15, wherein the flatness of the CCM and the friction coefficient of the material to be tested are positively correlated.

8. The method as claimed in claim 7, wherein the material to be tested is one selected from a group consisting of a silicon, a rubber, a silicon rubber, a polymer and a combination thereof.

9. The method as claimed in claim 7, wherein the friction coefficient is a static friction coefficient.

10. The method as claimed in claim 7, wherein the CCM is a double-sided CCM, and the material to be tested combines with at least one catalyst layer in the double-sided CCM to enhance the flatness of the double-sided CCM.

11. The method as claimed in claim 7, wherein the CCM manufacturing process is one selected from a group consisting of a direct coating, an ultrasonic spray method and a vacuum adsorption.

12. The method as claimed in claim 7, wherein the CCM manufacturing process is a manufacturing process performed under normal temperature.

13. A method for obtaining a catalyst coated membrane (CCM) having a flatness, comprising:
obtaining a friction coefficient of a material to be tested;
identifying whether the friction coefficient is within a range from 0.1 to 15 or not; and
if so, using the material to be tested in a CCM manufacturing process to obtain the CCM, wherein the flatness of the CCM and the friction coefficient of the material to be tested are positively correlated.

14. The method as claimed in claim 13, wherein the material to be tested is one selected from a group consisting of a silicon, a rubber, a silicon rubber, a polymer and a combination thereof.

15. The method as claimed in claim 13, wherein the friction coefficient is obtained by performing a friction testing for the material to be tested.

16. The method as claimed in claim 13, wherein the friction coefficient is obtained from one of a database and a product manual.

17. The method as claimed in claim 13, wherein the friction coefficient is a static friction coefficient.

18. The method as claimed in claim 13, wherein the CCM is a double-sided CCM, and the material to be tested combines with at least one catalyst layer in the double-sided CCM to enhance the flatness of the double-sided CCM.

19. The method as claimed in claim 13, wherein the CCM manufacturing process is one selected from a group consisting of a direct coating, an ultrasonic spray method and a vacuum adsorption.

20. The method as claimed in claim 13, wherein the CCM manufacturing process is a manufacturing process performed under normal temperature.
